(19) United States
(12) Patent Application Publication
(10) Pub. No.: US 2026/0326618 A1
(43) Pub. Date: Oct. 22, 2026

(54) A METHOD FOR CONTROLLING OPERATION OF A FUEL CELL SYSTEM OF A VEHICLE

(71) Applicant: VOLVO TRUCK CORPORATION, Göteborg (SE)

(72) Inventor: Pranav ARYA, Lindome (SE)

(73) Assignee: VOLVO TRUCK CORPORATION, Göteborg (SE)

(21) Appl. No.: 19/486,179

(22) PCT Filed: May 22, 2023
(86) PCT No.: PCT/EP2023/063658

§ 371 Date: Nov. 20, 2025

(51) Int. Cl. B60L 58/34

(52) U.S. Cl. CPC B60L 58/34; B60L 2240/12; B60L 2240/26; B60L 2240/64; B60L 2240/68; B60L 2260/54

(57) ABSTRACT

A method for controlling an operation of a fuel cell system of a vehicle includes estimating a power level profile of the fuel cell system, the power level profile corresponding to a requested power that is expected to be provided by the fuel cell system for the vehicle to travel from a first location to a second location, estimating a power threshold level of the fuel cell system, the power threshold level corresponding to a power level that the fuel cell system needs to provide to avoid freezing of the fuel cell system, determining a risk level of freezing of the fuel cell system by comparing the estimated power level profile with the estimated power threshold level, and in response to identifying that the determined risk level exceeds a threshold risk level, initiating a freeze prevention action.

### TECHNICAL FIELD

The disclosure relates generally to fuel cell vehicles. In particular aspects, the disclosure relates to a method for controlling operation of a fuel cell system of a vehicle. The disclosure also relates to a computer system, a computer program product, a control system, a non-transitory computer readable storage medium and a vehicle. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

In recent years, fuel cell systems have been considered as power sources for producing electric power in different applications, e.g., in fuel cell electric vehicles (FCEVs). Typically, a fuel cell system is used together with an energy storage system for providing electric power to various components of the fuel cell electric vehicle. The electric power may be used for powering one or more electric motors to create a propulsion force to the fuel cell electric vehicle.

One concern related to a fuel cell system used in a fuel cell electric vehicle is the potential risk of freezing in cold temperatures. The fuel cell system relies on an electrochemical reaction between hydrogen fuel and oxygen from the air to generate electricity. During this process, water is produced as a byproduct, which may condense and freeze within the fuel cell system in cold conditions. This may cause damage to fuel cell stacks as well as other components of the fuel cell system, leading to reduced efficiency and a potential failure of the system.

A freezing condition may occur when the fuel cell electric vehicle is parked in cold conditions. In this case, a freezing prevention action may be performed by expelling water from inside the fuel cell system. However, there is a risk that freezing conditions may occur even when the vehicle is in operation.

### SUMMARY

According to a first aspect of the disclosure, a computer system comprising a processing circuitry configured to control operation of a fuel cell system of a vehicle according to claim 1 is provided. The fuel cell system is configured to provide electric power for powering the vehicle. The processing circuitry is further configured to:
estimate a power level profile of the fuel cell system, the power level profile corresponding to a requested power that is expected to be provided by the fuel cell system for the vehicle to travel from a first location to a second location,
estimate a power threshold level of the fuel cell system, the power threshold level corresponding to a power level that the fuel cell system needs to provide to avoid freezing of the fuel cell system,
determine a risk level of freezing of the fuel cell system by comparing the estimated power level profile with the estimated power threshold level, and
in response to identifying that the determined risk level exceeds a threshold risk level, initiate a freeze prevention action.

The first aspect of the disclosure may seek to reduce a risk of freezing of the fuel cell system. A technical benefit may include that unnecessary degradation or damage of components of the fuel cell system may be avoided. As a result, continued safe and efficient operation of the fuel cell system may be ensured. According to the present disclosure, this benefit may be achieved by identifying a risk level of freezing of the fuel cell system and initiating a freeze prevention action. In particular, the risk level is determined by evaluating the power level profile of the fuel cell system, which corresponds to a requested power that is expected to be provided by the fuel cell system during travel from the first location to the second location. In general, during the operation of a fuel cell electric vehicle, the fuel cell system generates heat as a result of the electrochemical reaction that takes place within the system. By estimating the power that the fuel cell system is expected to provide during travel from the first to the second location, it may be possible to predict the heat generated by the fuel cell system at the estimated power level and thereby to determine if the generated heat is sufficient to overcome a heat loss caused by convection when the vehicle is moving. The risk level may thus be determined. In this way, the risk of freezing may be identified in a proactive manner thanks to the predictive approach, as opposed to conventional solutions of which monitor a real-time temperature of the fuel cell system using a temperature sensor.

The evaluation is performed by a comparison between the estimated power level profile with the power threshold level, which corresponds to a power level that the fuel cell system needs to provide to avoid freezing of the fuel cell system. Herein, the power threshold level may be understood as a cut-off point. If the power level provided by the fuel cell system falls below the threshold level, there is a risk that the heat generated by the fuel cell system may not be sufficient to counteract the heat loss, leading to the risk of freezing.

The power level profile may be understood as a power curve over time. It may represent a requested power level that is expected to be provided by the fuel cell system during a time period when the vehicle travels from the first location to the second location. The requested power level may be a constant level or may vary over time.

According to a second aspect of the disclosure, a computer-implemented method for controlling operation of a fuel cell system of a vehicle by a processing circuitry of a computer system according to claim 2 is provided. The fuel cell system is configured to provide electric power for powering the vehicle. The method comprises:
estimating, by the processing circuitry, a power level profile of the fuel cell system, the power level profile corresponding to a requested power that is expected to be provided by the fuel cell system for the vehicle to travel from a first location to a second location,
estimating, by the processing circuitry, a power threshold level of the fuel cell system, the power threshold level corresponding to a power level that the fuel cell system needs to provide to avoid freezing of the fuel cell system,
determining, by the processing circuitry, a risk level of freezing of the fuel cell system by comparing the estimated power level profile with the estimated power threshold level, and
in response to identifying that the determined risk level exceeds a threshold risk level, initiating, by the processing circuitry, a freeze prevention action.

Advantages and technical benefits of the second aspect of the disclosure are largely analogous to the advantages and technical benefits of the first aspect of the disclosure. It shall also be noted that all examples of the second aspect of the disclosure are combinable with all embodiments of the first aspect of the disclosure, and vice versa.

The computer-implemented method as disclosed herein may be performed in the processing circuitry of a processor device, such as in one or more electronic control units. The processor device may comprise a computing unit for estimating the power level profile of the fuel cell system and/or the power threshold level that the fuel cell system needs to provide to avoid freezing of the fuel cell system. The processor device may further comprise a communicating unit for communicating the initiation of the freeze prevention action with various vehicle systems.

Optionally in some examples, including in at least one preferred example, the freeze prevention action is initiated before the vehicle reaches the first location. As such, the action is performed in a proactive manner. A technical benefit may include that the risk of freezing is further reduced.

Optionally in some examples, including in at least one preferred example, the freeze prevention action comprises at least one of performing a heating operation for heating the fuel cell system, increasing a power output from the fuel cell system, and reducing a current vehicle speed. A technical benefit may include that a range of options for preventing the fuel cell system from freezing are provided. Specifically, performing a heating operation may help to quickly raise a temperature of the fuel cell system and thereby prevent any water from freezing inside the fuel cell system. Increasing the power output from the fuel cell system may cause the fuel cell system to generate more heat and thereby increase the temperature. A reduced vehicle speed may cause a lower heat loss as heat convection will decrease due to a lower wind speed.

Optionally in some examples, including in at least one preferred example, the heating operation is performed by heating a coolant and circulating the coolant through the fuel cell system. The coolant may be heated by a heat exchanger of a vehicle cooling system. As such, the heating operation is performed by use of existing components of the vehicle system and no additional heaters are required. A technical benefit may include that the heating is performed in an efficient manner.

Optionally in some examples, including in at least one preferred example, the heating operation is performed by at least one end plate heater disposed at one end of a fuel cell stack, or a convection heater. The convection heater may be installed in a compartment of the vehicle, which serves as an installation area for the fuel cell system.

Optionally in some examples, including in at least one preferred example, the method further comprises selecting the freeze prevention action based on an order of preference, wherein the action of performing a heating operation has a highest preference, and wherein the action of reducing a current vehicle speed has a lowest preference. In some examples, performing a heating operation may be carried out in combination with increasing a power output from the fuel cell system. The synergistic approach may maximize an effectiveness of freeze prevention actions and may enhance an overall performance of the fuel cell system, ensuring reliable operation even in cold environments.

Optionally in some examples, including in at least one preferred example, the method comprises, in response to selecting and initiating the action of increasing a power output from the fuel cell system, initiating a transfer of excessive power provided by the fuel cell system to an energy storage system of the vehicle. The energy storage system may comprise one or more batteries and may be considered as a second power source to provide electric power to the vehicle. A technical benefit may include that less energy will be wasted.

Optionally in some examples, including in at least one preferred example, in response to selecting and initiating the action of increasing a power output from the fuel cell system, initiating a dissipation of excessive power provided by the fuel cell system through an energy dissipating device.

Optionally in some examples, including in at least one preferred example, the energy dissipating device comprises a brake resistor or a brake compressor. In this case, the electric power may be dissipated as heat. The heat may be used for heating sections/components of the vehicle, e.g., for heating a vehicle cabin. In some examples, the heat may be used to heat the fuel cell system. In this case, increasing a power output from the fuel cell system is carried out in combination with performing a heating operation. In this way, it may eliminate the need for a significant increase of the power level since extra heat is provided to the fuel cell system. A technical benefit may include that less energy will be wasted.

Optionally in some examples, including in at least one preferred example, determining the risk level of freezing of the fuel cell system comprises determining whether at least a portion of the estimated power level profile is lower than the estimated power threshold level.

Optionally in some examples, including in at least one preferred example, in response to determining that at least a portion of the estimated power level profile is lower than the estimated power threshold level, evaluating the risk level by comparing a time duration of the at least a portion that is lower than the estimated power threshold level with a time duration threshold. In some examples, the time duration may be expressed as a percentage of a total travel time. As mentioned above, the power level profile may be a power curve over time, and it may represent a requested power level that is expected to be provided by the fuel cell system during a time period when the vehicle travels from the first location to the second location. In other words, the power level profile may be seen as a plot of a power level curve over the travel time. As such, in some examples, the risk level may be evaluated by determining the percentage of the time during which the estimated power level profile is lower than the estimated power threshold level. In this way, a more straightforward evaluation may be achieved. A technical benefit may include an improved evaluation of the risk of freezing of the fuel cell system.

Optionally in some examples, including in at least one preferred example, the method comprises, in response to the time duration of the at least a portion that is lower than the estimated power threshold level exceeding the time duration threshold, determining that the risk level exceeds the threshold risk level. Accordingly, the time duration threshold may also be expressed by a percentage of time. Purely by way of example, if the estimated power level profile is lower than the power threshold level for more than 90% of the travel time, it may be determined that the risk level of freezing exceeds the threshold risk level.

Optionally in some examples, including in at least one preferred example, the power threshold level is estimated based on at least one of a current vehicle speed, an ambient condition and/or a thermal model of the fuel cell system. The power threshold level may be estimated such that when the power provided by the fuel cell system is below the threshold level, the heat loss due to convention is higher than the heat generated by the fuel cell system, leading to a risk of freezing. By taking various parameters into consideration, a more appropriate power threshold level may be estimated. A technical benefit may include an improved estimation of the power threshold level which corresponds to a power level that the fuel cell system needs to provide to avoid freezing of the fuel cell system.

Optionally in some examples, including in at least one preferred example, estimating the power level profile of the fuel cell system comprises estimating a total requested power for powering the vehicle to travel from the first location to the second location and a subsequent power split between the fuel cell system and other power sources of the vehicle. A technical benefit may include that an accurate power level profile of the fuel cell system may be estimated.

Optionally in some examples, including in at least one preferred example, the total requested power is estimated based on at least one of a current vehicle speed, a vehicle gross combination weight, information about the route that the vehicle is currently travelling on including at least one of terrain information, speed limit information, and traffic information. By taking various parameters into consideration, a more accurate total requested power may be estimated. A technical benefit may include an improved estimation of the requested power that is expected to be provided by the fuel cell system for the vehicle to travel from the first location to the second location.

According to a third aspect of the disclosure, a computer program product comprising program code for performing the method according to the second aspect of the disclosure is provided.

According to a fourth aspect of the disclosure, a control system comprising one or more control units configured to perform the method according to the second aspect of the disclosure is provided.

According to a fifth aspect of the disclosure, a non-transitory computer-readable storage medium comprising instructions is provided. The non-transitory computer-readable storage medium comprises instructions, which when executed by the processor device, cause the processor device to perform the method according to the second aspect of the disclosure.

According to a sixth aspect of the disclosure, a vehicle comprising a fuel cell system configured to provide electric power for powering the vehicle is provided. The vehicle further comprises the computer system according to the first aspect of the disclosure and/or the control system according to the fourth aspect of the disclosure.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 is a schematic side view of an exemplary vehicle comprising a fuel cell system in accordance with an example of the present disclosure.

FIG. 2a is a diagram illustrating another example of a vehicle.

FIG. 2b is a diagram illustrating an exemplary of a fuel cell system in accordance with an example of the present disclosure.

FIG. 3 is a flowchart illustrating an exemplary method of controlling operation of the fuel cell system, in accordance with an example of the present disclosure.

FIG. 4 is another flowchart illustrating an exemplary method of controlling operation of the fuel cell system, in accordance with an example of the present disclosure.

FIG. 5 is a schematic diagram of an exemplary computer system for implementing examples disclosed herein, in accordance with an example of the present disclosure.

### DETAILED DESCRIPTION

The detailed description set forth below provides information and examples of the disclosed technology with sufficient detail to enable those skilled in the art to practice the disclosure.

One concern related to a fuel cell system used in a fuel cell electric vehicle is the potential risk of freezing in cold temperatures. The fuel cell system relies on an electrochemical reaction between hydrogen fuel and oxygen from the air to generate electricity. During this process, water is produced as a byproduct, which may condense and freeze within the fuel cell system in cold conditions. This may cause damage to fuel cell stacks as well as other components of the fuel cell system, leading to reduced efficiency and a potential failure of the system.

A freezing condition may occur when the fuel cell electric vehicle is parked in cold conditions. In this case, a freezing prevention action may be performed by expelling water from inside the fuel cell system. However, there is a risk that freezing conditions can occur even when the vehicle is in operation. For example, if a fuel cell electric vehicle operates at high speed while the fuel cell system is in a low-power state, heat loss through convection may surpass the heat generated by the fuel cell system. This may pose a risk of freezing of the fuel cell system.

The present disclosure may seek to reduce the risk of freezing. A technical benefit may include that unnecessary degradation or damage of components of the fuel cell system may be avoided.

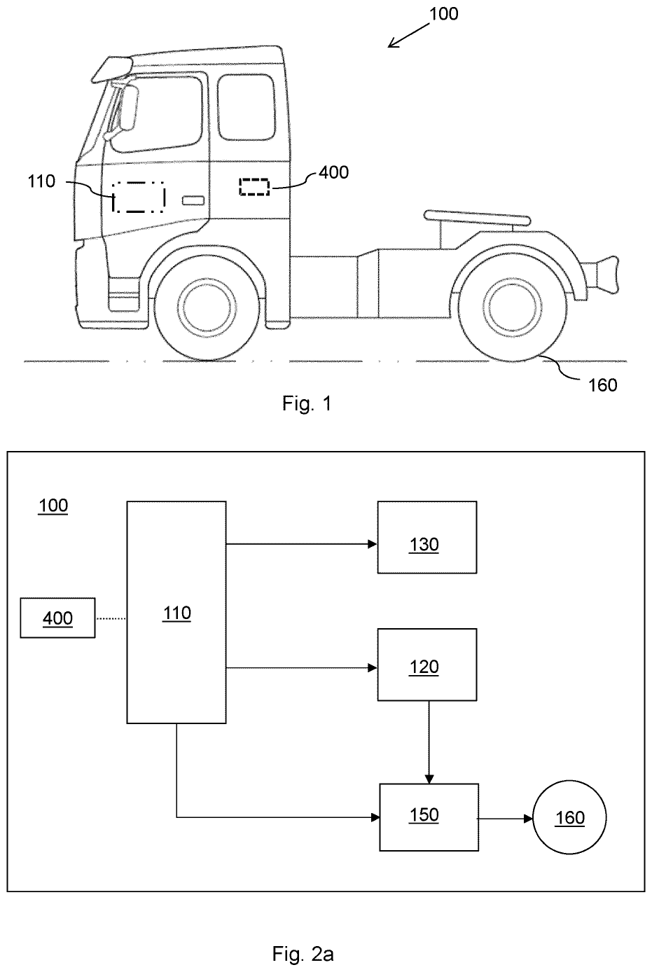

FIG. 1 depicts a vehicle 100, which is exemplified by a fuel cell electric truck. Even though a fuel cell electric truck is shown, it shall be noted that the disclosure is not limited to this type of vehicle, but it may also be used for other fuel cell electric vehicles, such as a bus, or construction equipment, e.g., a wheel loader or an excavator.

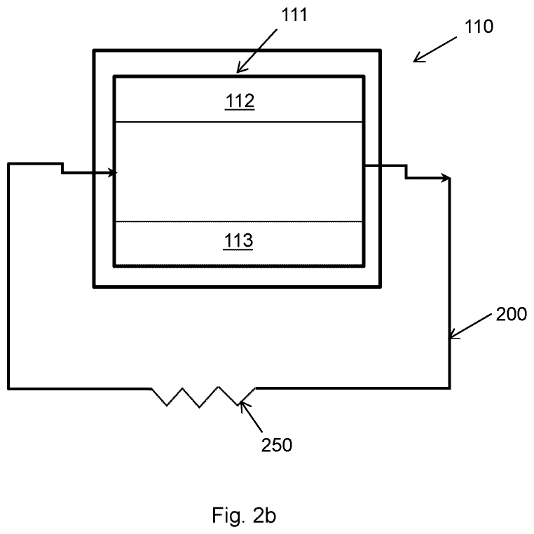

FIG. 2a is a diagram illustrating the exemplary vehicle 100 shown in FIG. 1.

The vehicle 100 comprises a fuel cell system 110 and an electric energy storage system 120, typically comprising one or more batteries. The fuel cell system 110 is adapted to produce electric power. The produced electric power may be fed to one or more electric motors 150, which are configured for providing propulsion power to driven wheels 160 of the vehicle 100. The electric power produced by the fuel cell system 110 may also be used to charge the one or more batteries of the energy storage system 120. Power stored in the electric energy storage system 120 may further be fed to the one or more electric motors 150. In some examples, the fuel cell system 110 may produce more electric power than what is requested to power the vehicle 100 and/or that can be stored in the electric energy storage system 120. In this case, excessive electric power may be transferred to an energy dissipation device 130. The vehicle 100 may further comprise a convection heater (not shown), configured to maintain a temperature of a compartment of the vehicle 100, which serves as an installation area for the fuel cell system 110.

The vehicle 100 may be operated in different operating modes. For instance, it may be operated in a hybrid mode in which energy for powering the vehicle 100 is supplied by the fuel cell system 110 as well as the energy storage system 120. Alternately, it may be operated in a BEV mode in which energy for powering the vehicle 100 is solely provided from batteries of the energy storage system 120.

The vehicle 100 further comprises a control system 400. The control system 400 may comprise one or more control units 402, which may also be referred to as one or more processor devices 402. The one or more processor devices 402, comprising one or more processing circuits, may be configured to control the operation of the fuel cell system 110 using a method according to an example of the disclosure.

FIG. 2b illustrates an example of the fuel cell system 110. The fuel cell system 110 may comprise a plurality of fuel cell stacks 111. Each fuel cell stack 111 comprises electrodes in the form of an anode 112, a cathode 113 and an electrolyte sandwiched between the electrodes 112, 113. The fuel cell stack 111 may be provided with an end plate heater (not shown), disposed on an outer side of the fuel cell stack 111. The vehicle 100 may further comprise a cooling system (not shown) which may include a cooling branch. The cooling branch may be implemented as a coolant circulating circuit 200 in the form of a loop comprising a conduit, or a series of conduits, in which a coolant pump (not shown) circulates a suitable coolant. The cooling branch may further comprise a heat exchanger 250, for instance, a radiator of the vehicle 100, that may allow an air-to-liquid heat exchange for cooling the coolant flown in the circuit. In some other examples, the heat exchanger 250 may be arranged in a preliminary cooling circuit of the cooling system.

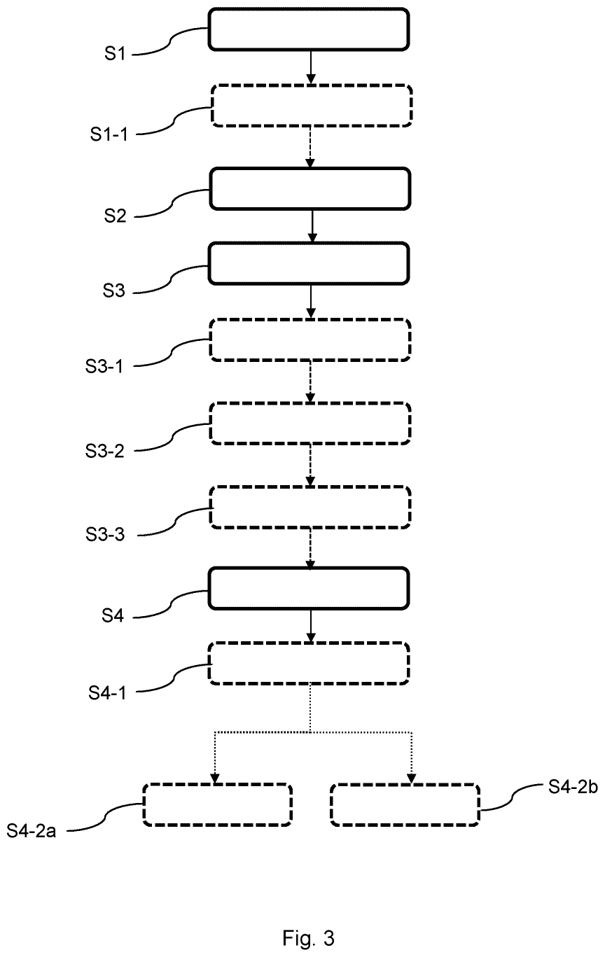

FIG. 3 is a flowchart illustrating an exemplary method of controlling the operation of the fuel cell system 110. The method may be applied to any type of fuel cell electric vehicles, e.g., the truck 100 shown in FIG. 1. The method may be performed by a processing circuitry of the processor device 402 shown in FIG. 1. The method comprises the steps listed in the following, which, unless otherwise indicated, may be taken in any suitable order.

S1: estimating a power level profile of the fuel cell system 110, the power level profile corresponding to a requested power that is expected to be provided by the fuel cell system 110 for the vehicle 100 to travel from a first location to a second location.

The power level profile may be understood as a power curve over time. It may represent a requested power level that is expected to be provided by the fuel cell system during a time period when the vehicle travels from the first location to the second location. The power level may be a constant level or may vary over time.

In some examples, estimating the power level profile of the fuel cell system comprises an optional sub-step S1-1: estimating a total requested power for powering the vehicle 100 to travel from the first location to the second location and a subsequent power split between the fuel cell system 110 and other power sources of the vehicle 100, e.g., the energy storage system 120.

In some examples, the total requested power is estimated based on at least one of a current vehicle speed, a vehicle gross combination weight, information about the route that the vehicle 100 is currently travelling on including at least one of terrain information, speed limit information, and traffic information. Various vehicle sensors may be configured to gather the above information and to report the information to the processor device 402.

S2: estimating a power threshold level of the fuel cell system 110, the power threshold level corresponding to a power level that the fuel cell system 110 needs to provide to avoid freezing of the fuel cell system 110. The power threshold level may be understood as a cut-off point, such that if the power provided by the fuel cell system 110 falls below the threshold level, the heat generated by the fuel cell system 110 may not be sufficient to counteract the heat loss, leading to a risk of freezing.

In some examples, the power threshold level is estimated based on at least one of a current vehicle speed, an ambient condition and/or a thermal model of the fuel cell system 110. Purely by way of example, the thermal model may be a mathematical representation that describes how heat is generated, transferred, and dissipated within the fuel cell system 110. The thermal model may include various parameters such as the temperature of the reactant gases, the temperature distribution within the cell, a thermal conductivity of the cell components, and heat transfer coefficients between the fuel cell components and surrounding environment. The estimation of the power threshold level may be performed using the thermal model of the fuel cell system 110 in combination with an estimation of a heat loss to the surrounding environment.

S3: determining a risk level of freezing of the fuel cell system 110 by comparing the estimated power level profile with the estimated power threshold level.

In some examples, determining the risk level of freezing of the fuel cell system 110 comprises an optional sub-step S3-1: determining whether at least a portion of the estimated power level profile is lower than the estimated power threshold level.

In some examples, determining the risk level of freezing of the fuel cell system 110 comprises an optional sub step S3-2: in response to determining that at least a portion of the estimated power level profile is lower than the estimated power threshold level, evaluating the risk level by comparing a time duration of the at least a portion that is lower than the estimated power threshold level with a time duration threshold.

In some examples, the time duration may be expressed as a percentage of a total time duration. As mentioned above, the power level profile may be a power curve over time, and it may represent a requested power level that is expected to be provided by the fuel cell system 110 during a time period when the vehicle 100 travels from the first location to the second location. In other words, the power level profile may be seen as a plot of a power curve over the travel time. As such, in some examples, the risk level of freezing may be evaluated by determining the percentage of the time during which the estimated power level profile is lower than the estimated power threshold level.

In some examples, determining the risk level of freezing of the fuel cell system 110 comprises an optional sub-step S3-3: in response to the time duration of the at least a portion that is lower than the estimated power threshold level exceeding the time duration threshold, determining that the risk level exceeds the threshold risk level. Accordingly, the time duration threshold may also be expressed by a percentage of time. Purely by way of example, if the power level profile is lower than the power threshold level for more than 90% of the travel time, the processor device 402 may determine that the risk level exceeds the threshold risk level.

S4: in response to identifying that the determined risk level exceeds a threshold risk level, initiating a freeze prevention action.

In some examples, the freeze prevention action comprises at least one of performing a heating operation for heating the fuel cell system 110, increasing a power output from the fuel cell system 110, and reducing a current vehicle speed. Specifically, performing a heating operation may help to quickly raise the temperature of the fuel cell system 110 and thereby prevent any water from freezing inside the fuel cell system 110. Increasing the power output from the fuel cell system 110 may cause the fuel cell system to generate more heat and thereby increase the temperature. A reduced vehicle speed may result in a lower heat loss as heat convection will decrease due to a lower wind speed.

In some examples, the heating operation is performed by heating a coolant and circulating the coolant through the fuel cell system 110. The coolant may be heated by the heat exchanger 250 of a vehicle cooling system.

In some examples, the heating operation is performed by at least one end plate heater (not shown) disposed at one end of a fuel cell stack 111, or a convection heater. The convection heater may be installed in a compartment of the vehicle 100, which serves as an installation area for the fuel cell system.

In some examples, the method further comprises an optional sub-step S4-1: selecting the freeze prevention action based on an order of preference, wherein the action of performing a heating operation has a highest preference, and wherein the action of reducing a current vehicle speed has a lowest preference. In some examples, performing a heating operation is carried out in combination with increasing a power output from the fuel cell system 110.

In some examples, the method further comprises an optional sub-step S4-2a: in response to selecting and initiating the action of increasing a power output from the fuel cell system 110, initiating a transfer of excessive power provided by the fuel cell system 110 to an energy storage system 120 of the vehicle 100.

In some examples, the method further comprises an optional sub-step S4-2b: in response to selecting and initiating the action of increasing a power output from the fuel cell system 110, initiating a dissipation of excessive power provided by the fuel cell system 110 through an energy dissipating device 130.

In some examples, the energy dissipating device 130 comprises a brake resistor or a brake compressor. In this case, the electric power may be dissipated as heat. The heat may be used for heating sections/components of the vehicle, e.g., for heating a vehicle cabin. In some examples, the heat may be used for heating the fuel cell system 110. In this case, increasing a power output from the fuel cell system 110 is carried out in combination with performing a heating operation. In this way, it may eliminate the need for a significant increase of the power level since extra heat is provided to the fuel cell system.

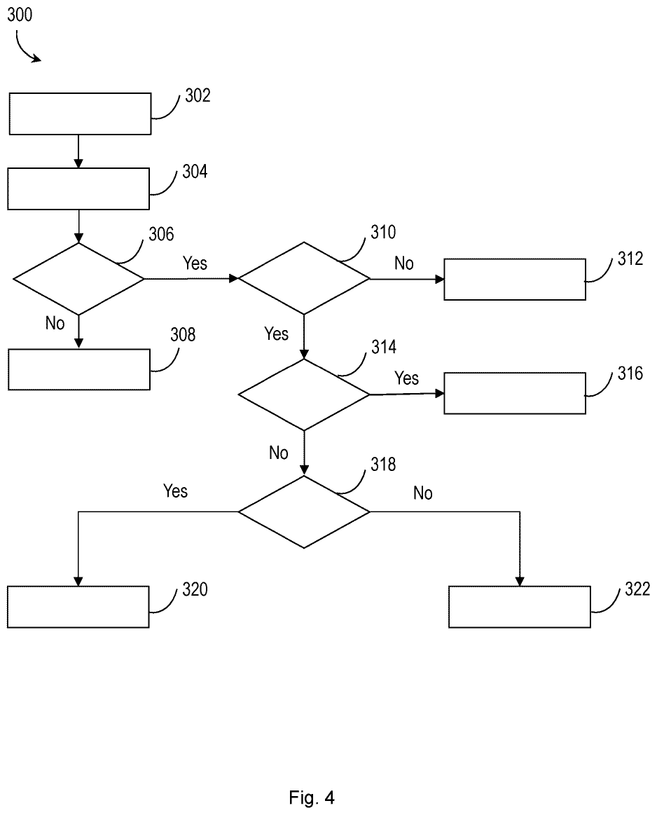

FIG. 4 shows another flowchart illustrating a process 300 of operating the fuel cell system 110.

The process 300 includes acts or steps of the exemplary method shown in FIG. 3. Therefore, the detailed description of the steps is not repeated.

The process 300 comprises the following blocks:
Block 302: estimate a power level profile of the fuel cell system 110. The power level profile corresponds to a requested power that is expected to be provided by the fuel cell system 110 for the vehicle 100 to travel from a first location to a second location. This step is similar to S1 in FIG. 3.
Block 304: estimate a power threshold level of the fuel cell system 110. The power threshold level corresponds to a power level that the fuel cell system 110 needs to provide to avoid freezing of the fuel cell system 110. This step is similar to S2 in FIG. 3.
Block 306: compare the estimated power level profile with the estimated power threshold level. This step is similar to S3-1, which is a sub-step of S3 in FIG. 3. In this step, the processor device may perform an initial check to determine if there is a potential risk of freezing.
Block 308: operate the fuel cell system 110 to provide the requested power. When it is determined that the estimated power level profile is not lower, e.g., higher, than the estimated power threshold level (“No”), the processor device 402 may proceed to block 308. The processor device 402 may determine that there is no risk of freezing and may control the fuel cell system 110 to provide the requested power for the vehicle 100 to travel from the first position to the second position.
Block 310: determine whether a risk level of freezing is high. When it is determined that the estimated power level profile is lower than the estimated power threshold level (“Yes”), or at least a portion of the estimated power level profile is lower than the estimated power threshold level (“Yes”), the processor device 402 may proceed to block 310. The processor device 402 may further analyze the power level profile with regard to the power threshold level and thereby determine the risk level of freezing. The analysis may be performed by comparing a time duration of the at least a portion being lower than the estimated power threshold level with a time duration threshold. This step is similar to S3-2 and S3-3, which are sub-steps of S3 in FIG. 3.
Block 312: operate the fuel cell system 110 to provide the requested power. When it is determined that the risk level of freezing is not high (“No”), e.g., lower than a threshold risk level, the processor device 402 may proceed to block 312. The processor device may control the fuel cell system 110 to provide the requested power for the vehicle 100 to travel from the first position to the second position.
Block 314: determine if it is possible to perform a heat operation for heating the fuel cell system 110. When it is determined that the risk level of freezing is high (“Yes”), the processor device 402 may proceed to block 314, It may check if it is possible to perform a heating operation for heating the fuel cell system. For example, the processor device 402 may, check whether the vehicle cooling system and/or the heat exchanger 250 is in operation at the moment and/or whether the heat exchanger 250 is available to heat the coolant to be recirculated through the fuel cell system 110.
Block 316: perform a heat operation a heating operation for heating the fuel cell system 110. When it is determined that it is possible to perform a heating operation (“Yes”), the processor device 402 may proceed to block 316. The processor device 402 may initiate a suitable heating operation. The heating operation may be performed by heating a coolant and circulating the coolant through the fuel cell system 110. Alternatively, or additionally, the heating operation may be performed by at least one end plate heater disposed at one end of a fuel cell stack 111, or the convection heater, which may be installed in a compartment of the vehicle 100.
Block 318: determine if it is possible to increase a power output from the fuel cell system. When it is determined that it is not possible to perform a heating operation (“No”), the processor device 402 may proceed to block 318. The processor device 402 may further verify whether it is feasible to increase the power output from the fuel cell system 110. The processor device 402 may check a current power level of the fuel cell system 110, and verify an availability of sufficient hydrogen fuel in the fuel tank. This verification may ensure that the fuel cell system 110 can sustain an increased power output without any adverse effects.
Block 320: initiate a transfer of excessive power provided by the fuel cell system 110 to an energy storage system 120 or to an energy dissipating device 130. When it is determined that it is possible to increase a power output from the fuel cell system 110 (“Yes”), the processor device 402 may proceed to block 320. Depending on a current state-of-energy level of the energy storage system 120, the excessive power may be used to charge the one or more batteries of the energy storage system 120. Alternatively, or additionally, the excessive power may be transferred to the energy dissipating device 130 and may be dissipated as heat. The heat may be used for heating sections/components of the vehicle, e.g., for heating a vehicle cabin. The heat may also be used for heating the fuel cell system 110.
Block 322: reduce a current vehicle speed. When it is determined that it is not possible to increase a power output from the fuel cell system 110 (“No”), the processor device 402 may proceed to block 322. The processor device 402 may calculate a target speed at which the fuel cell system 110 is at a reduced risk for freezing due to lower heat loss. Thereafter, the processor device 402 may initiate a reduction of the current vehicle speed to the target speed.

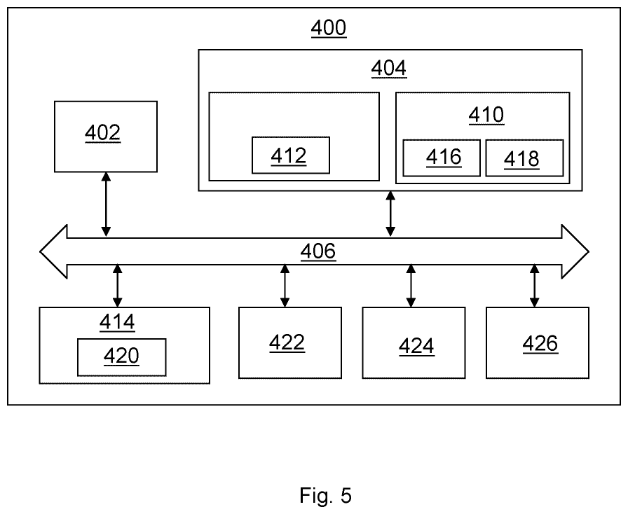

The disclosure also relates to a computer system 400, as e.g. shown in FIG. 5. The computer system 400 comprises a processing circuitry 402 configured to control operation of fuel cell system 110 of a vehicle 100, wherein the fuel cell system 110 is configured to provide electric power for powering the vehicle 100. The processing circuitry is further configured to:
estimate a power level profile of the fuel cell system 110, the power level profile corresponding to a requested power that is expected to be provided by the fuel cell system 110 for the vehicle 100 to travel from a first location to a second location,
estimate a power threshold level of the fuel cell system 110, the power threshold level corresponding to a power level that the fuel cell system 110 needs to provide to avoid freezing of the fuel cell system 110,
determine a risk level of freezing of the fuel cell system 110 by comparing the estimated power level profile with the estimated power threshold level, and
in response to identifying that the determined risk level exceeds a threshold risk level, initiate a freeze prevention action.

The computer system 400 may comprise at least one computing device or electronic device capable of including firmware, hardware, and/or executing software instructions to implement the functionality described herein. The computer system 400 may include one or more electronic control units 402, such as the control unit 402 illustrated in FIG. 1, which may also be referred to as a processor device, a memory 404, and a system bus 406. The computer system 400 may include at least one computing device having the control unit 402. The system bus 406 provides an interface for system components including, but not limited to, the memory 404 and the control unit 402. The control unit 402 may include any number of hardware components for conducting data or signal processing or for executing computer code stored in memory 404. The control unit 402 (e.g., processor device) may, for example, include general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The control unit may further include computer executable code that controls operation of the programmable device.

The system bus 406 may be any of several types of bus structures that may further interconnect to a memory bus (with or without a memory controller), a peripheral bus, and/or a local bus using any of a variety of bus architectures. The memory 404 may be one or more devices for storing data and/or computer code for completing or facilitating methods described herein. The memory 404 may include database components, object code components, script components, or other types of information structure for supporting the various activities herein. Any distributed or local memory device may be utilized with the systems and methods of this description. The memory 404 may be communicably connected to the control unit 402 (e.g., via a circuit or any other wired, wireless, or network connection) and may include computer code for executing one or more processes described herein. The memory 404 may include non-volatile memory 408 (e.g., read-only memory (ROM), erasable programmable read-only memory (EPROM), electrically erasable programmable read-only memory (EEPROM), etc.), and volatile memory 410 (e.g., random-access memory (RAM)), or any other medium which can be used to carry or store desired program code in the form of machine-executable instructions or data structures and which can be accessed by a computer or other machine with a control unit 402. A basic input/output system (BIOS) 412 may be stored in the non-volatile memory 408 and can include the basic routines that help to transfer information between elements within the computer system 400.

The computer system 400 may further include or be coupled to a non-transitory computer-readable storage medium such as the storage device 414, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 414 and other drives associated with computer-readable media and computer-usable media may provide non-volatile storage of data, data structures, computer-executable instructions, and the like.

A number of modules can be implemented as software and/or hard-coded in circuitry to implement the functionality described herein in whole or in part. The modules may be stored in the storage device 414 and/or in the volatile memory 410, which may include an operating system 416 and/or one or more program modules 418. All or a portion of the examples disclosed herein may be implemented as a computer program product 420 stored on a transitory or non-transitory computer-usable or computer-readable storage medium (e.g., single medium or multiple media), such as the storage device 414, which includes complex programming instructions (e.g., complex computer-readable program code) to cause the control unit 402 to carry out the steps described herein. Thus, the computer-readable program code can comprise software instructions for implementing the functionality of the examples described herein when executed by the control unit 402. The control unit 402 may serve as a controller or control system for the computer system 400 that is to implement the functionality described herein, such as for the control system 4 illustrated in FIG. 2.

The computer system 400 also may include an input device interface 422 (e.g., input device interface and/or output device interface). The input device interface 422 may be configured to receive input and selections to be communicated to the computer system 400 when executing instructions, such as from a keyboard, mouse, touch-sensitive surface, etc. Such input devices may be connected to the processor device 402 through the input device interface 422 coupled to the system bus 406 but can be connected through other interfaces such as a parallel port, an Institute of Electrical and Electronic Engineers (IEEE) 1394 serial port, a Universal Serial Bus (USB) port, an IR interface, and the like. The computer system 400 may include an output device interface 424 configured to forward output, such as to a display, a video display unit (e.g., a liquid crystal display (LCD) or a cathode ray tube (CRT)). The computer system 400 may also include a communications interface 426 suitable for communicating with a network as appropriate or desired.

The operational steps described in any of the exemplary aspects herein are described to provide examples and discussion. The steps may be performed by hardware components, may be embodied in machine-executable instructions to cause a processor to perform the steps, or may be performed by a combination of hardware and software. Although a specific order of method steps may be shown or described, the order of the steps may differ. In addition, two or more steps may be performed concurrently or with partial concurrence.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

1. A computer system comprising a processing circuitry configured to control operation of a fuel cell system of a vehicle, wherein the fuel cell system is configured to provide electric power for powering the vehicle, the processing circuitry being further configured to:
estimate a power level profile of the fuel cell system, the power level profile corresponding to a requested power that is expected to be provided by the fuel cell system for the vehicle to travel from a first location to a second location,
estimate a power threshold level of the fuel cell system, the power threshold level corresponding to a power level that the fuel cell system needs to provide to avoid freezing of the fuel cell system,
determine a risk level of freezing of the fuel cell system by comparing the estimated power level profile with the estimated power threshold level, and
in response to identifying that the determined risk level exceeds a threshold risk level, initiate a freeze prevention action.

2. A computer-implemented method for controlling operation of a fuel cell system of a vehicle, by a processing circuitry of a computer system, wherein the fuel cell system is configured to provide electric power for powering the vehicle, the method comprising:
estimating, by the processing circuitry, a power level profile of the fuel cell system the power level profile corresponding to a requested power that is expected to be provided by the fuel cell system for the vehicle to travel from a first location to a second location,
estimating, by the processing circuitry, a power threshold level of the fuel cell system, the power threshold level corresponding to a power level that the fuel cell system needs to provide to avoid freezing of the fuel cell system
determining, by the processing circuitry, a risk level of freezing of the fuel cell system by comparing the estimated power level profile with the estimated power threshold level, and
in response to identifying that the determined risk level exceeds a threshold risk level, initiating, by the processing circuitry, a freeze prevention action.

3. The method according to claim 2, wherein the freeze prevention action is initiated before the vehicle reaches the first location.

4. The method according to claim 2, wherein the freeze prevention action comprises at least one of performing a heating operation for heating the fuel cell system, increasing a power output from the fuel cell system, and reducing a current vehicle speed.

5. The method according to claim 4, wherein the heating operation is performed by heating a coolant and circulating the coolant through the fuel cell system.

6. The method according to claim 4, wherein the heating operation is performed by at least one end plate heater disposed at one end of a fuel cell stack, or a convection heater.

7. The method according to claim 4, wherein the method further comprises selecting the freeze prevention action based on an order of preference, wherein the action of performing a heating operation has a highest preference, and wherein the action of reducing a current vehicle speed has a lowest preference.

8. The method according to claim 7, further comprising, in response to selecting and initiating the action of increasing a power output from the fuel cell system, initiating transfer of excessive power provided by the fuel cell system to an energy storage system of the vehicle.

9. The method according to claim 7 further comprising, in response to selecting and initiating the action of increasing a power output from the fuel cell system, initiating a dissipation of excessive power provided by the fuel cell system through an energy dissipating device.

10. The method according to claim 9, wherein the energy dissipating device comprises a brake resistor or a brake compressor.

11. The method according to claim 2, wherein determining the risk level of freezing of the fuel cell system comprises determining whether at least a portion of the estimated power level profile is lower than the estimated power threshold level.

12. The method according to claim 11, further comprising, in response to determining that at least a portion of the estimated power level profile is lower than the estimated power threshold level, evaluating the risk level by comparing a time duration of the at least a portion that is lower than the estimated power threshold level with a time duration threshold.

13. The method according to claim 12, further comprising, in response to the time duration of the at least a portion that is lower than the estimated power threshold level exceeding the time duration threshold, determining that the risk level exceeds the threshold risk level.

14. The method according to claim 2, wherein the power threshold level is estimated based on at least one of a current vehicle speed, an ambient condition and/or a thermal model of the fuel cell system.

15. The method according to claim 2, wherein estimating the power level profile of the fuel cell system comprises estimating a total requested power for powering the vehicle to travel from the first location to the second location and a subsequent power split between the fuel cell system and other power sources of the vehicle.

16. The method according to claim 15, wherein the total requested power is estimated based on at least one of a current vehicle speed, a vehicle gross combination weight, information about the route that the vehicle is currently travelling on including at least one of terrain information, speed limit information, and traffic information.

17. A computer program product comprising program code for performing, when executed by the processing circuitry, the method of claim 2.

18. A control system comprising one or more control units configured to perform the method of claim 2.

19. A non-transitory computer-readable storage medium comprising instructions, which when executed by the processing circuitry, cause the processing circuitry to perform the method of claim 2.

20. A vehicle comprising a fuel cell system configured to provide electric power for powering the vehicle, and further comprising the computer system according to claim 1.
